(19) United States
(12) Patent Application Publication
(10) Pub. No.: US 2026/0263326 A1
(43) Pub. Date: Sep. 10, 2026

(54) Liquid Dosing System with One-Piece Flip-Top Container Closure

(71) Applicant: Aurora Pharmaceutical, Inc., Northfield, MN (US)

(72) Inventors: Michael STROBEL, Northfield, MN (US); Richard MIHALIK, Faribault, MN (US)

(73) Assignee: Aurora Pharmaceutical, Inc., Northfield, MN (US)

(21) Appl. No.: 19/543,294

(22) Filed: Feb. 18, 2026

Related U.S. Application Data
(60) Provisional application No. 63/760,357, filed on Feb. 19, 2025.

(51) Int. Cl. A61J 1/20; A61J 1/14

(52) U.S. Cl. CPC A61J 1/2096; A61J 1/1418

(57) ABSTRACT

A liquid dosing system is disclosed comprising a one-piece flip-top container closure configured for hygienic and dual-mode dispensing of medicinal liquids without removal of the cap. The closure includes a primary cap adapted to secure to a container neck and a hinged flip-top lid integrally formed therewith. A dispensing orifice is provided in a top wall of the primary cap and is dimensioned to form a fluid-tight seal with a syringe tip, including compatibility with slip-tip and luer lock syringes. The flip-top lid includes an inwardly projecting protrusion aligned with the dispensing orifice, the protrusion sealing the orifice when the lid is closed to protect dispensing surfaces from contamination and prevent leakage. The system enables selective dispensing without cap removaleither by drawing liquid directly into a syringe through the orifice or by pouring liquid into a separate measuring device, without cap removal. Optional features include an annular groove for an O-ring seal, a liquid-tight vent to reduce vacuum during large-volume withdrawal, and alternative fittings for connection to dosing devices

### CROSS-REFERENCE TO RELATED APPLICATIONS

This Non-provisional application claims the benefit of the filing date of U.S. provisional application Ser. No. 63/760,357, filed on 19 February, 2025, the entirety of the disclosure of which is herein incorporatated by reference.

### FIELD OF THE INVENTION

The disclosure relates generally to medicinal liquid dosing systems, and more particularly, to a medicinal liquid dosing system comprising a flip-top container closure adapted for dispensing medicinal liquid into a syringe or directly into a different measuring device, without the need for removal of the container cap.

### BACKGROUND

Medicinal liquid dosing systems are commonly used for dispensing medicinal liquids in controlled quantities for various applications, such as medicine administration, chemical mixing, or cooking. These systems typically involve a container closure that includes an orifice for dispensing the medicinal liquid.

Existing medicinal container closures often require removal or replacement of the cap for different types of medicinal liquid dispensing, whether by direct pouring or by using a syringe or measuring device. This can lead to the risk of contamination, loss of liquid, or difficulty in achieving accurate dispensing quantities.

Additionally, known medicinal container caps such as septum caps may expose dispensing surfaces to the environment when not in use, increasing the likelihood of contamination or spillage of the medicinal liquid. Further, these caps do not commonly form perfect seals, do not have vents for larger draws, and are not designed for use with luer lock syringes.

Press-in bottle adaptors (PIBA) are also commonly used. These are pressed into the neck of the container to partially plug while leaving a partial orifice in the neck of the bottle which seals against slip-tip syringes. Although PIBA allow accurate measurement of medicinal liquids without the elastomer fatigue found in septum caps, they still have many of the septum cap disadvantages such as lack of compatibility with luer lock syringes or vents for larger volumes. Bottle contents are also not easily dispensed into a larger measuring device such as a teaspoon or a medicine cup because the PIBA must be removed for pouring. and when pouring viscous liquids would likely drip down the side of the container.

A fourth way is a dropper tip type orifice with a custom syringe tip designed to fit tightly over it. This design has all the advantages of the flip-top cap and syringe in this invention, except for the following. This design does not accommodate a vent. The cap is fully removed, allowing for potential contamination, misplacement or loss of the cap. The syringe only works with the custom syringe specifically designed for the tip. If the syringe becomes worn, damaged or contaminated, it cannot be replaced with other easily commercially available ones like a design that is compatible with luer lock or slip tip designs. These dropper tips also do not accommodate delivery of larger volumes due to the small diameter of the dropper tip and the fact that they are either inserted or welded on.

Thus, there is a need for an improved liquid dosing system that offers dual dispensing capabilities and protects the dispensing surfaces from contamination, all while eliminating the need for cap removal.

### SUMMARY

Disclosed is a liquid dosing system comprising a one-piece flip-top vessel closure that includes a syringe-compatible orifice. The system allows for liquid to be dispensed either through the orifice into a syringe or by directly pouring the liquid into a measuring device, all without the need to remove the cap. Additionally, the system includes a protective closure mechanism to shield the dispensing surfaces from contamination when not in use, ensuring hygienic storage of the vessel and its contents.

One key feature of the system includes a one-piece closure encompassing a flip-top lid and an orifice under the lid of a suitable diameter to tightly seal against a dispensing syringe, allowing for precise and controlled dispensing of liquid into the syringe. The flip top lid additionally includes a protrusion on the inner surface that matches the cap orifice diameter so the protrusion can seal against the orifice when the lid is closed, protecting the dispensing surfaces from contamination when the vessel is not in use.

They system has a dual-use dispensing capability, wherein the closure may be used with a syringe to dispense liquid through the orifice directly into a syringe or used without a syringe to dispense liquid directly into a different measuring device such as a measuring cup. Both types of dispensing can be done without removing the cap from the bottle.

The disclosure's convenient, hygienic, and versatile liquid dosing system is suitable for a wide range of applications.

### BRIEF DESCRIPTION OF THE DRAWINGS

FIG. 1—Perspective view of the liquid dosing system showing the cap with primary cap and flip-top lid on a neck of a container.

FIG. 2—Cross-sectional view of the closure mechanism with the flip-top lid in the closed position, showing the protrusion on the inner surface of the lid sealing against the orifice in the cap.

FIG. 3—Close-up perspective view showing the liquid dispensing system in use with a syringe fitted into the dispensing orifice for liquid dispensing.

FIG. 4—Additional perspective view showing the liquid dispensing system in use with a syringe fitted into the dispensing orifice for liquid dispensing.

FIG. 5A—Demonstrates an additional embodiment of the liquid dispensing system with an annular groove capable of fitting an o-ring.

FIG. 5B—Demonstrates the additional embodiment of FIG. 5A with a liquid tight vent in addition to the annular groove.

### DETAILED DESCRIPTION

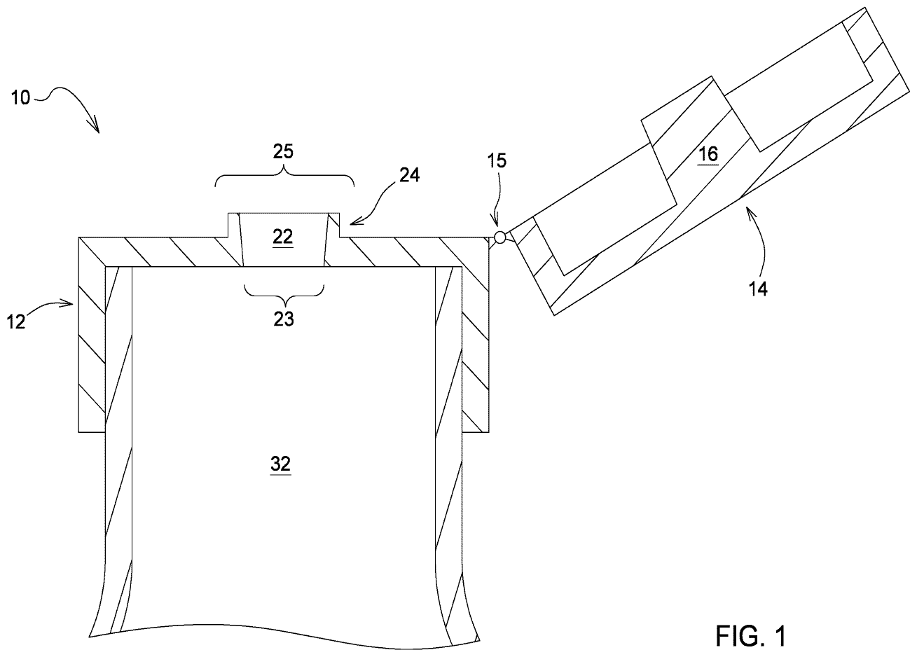

FIGS. 1 to 5B show the liquid dispensing system. The system comprises a cap 10. In many embodiments, cap 10 is injection molded and comprises a primary cap 12 which is generally cylindrical and cup-shaped and adapted to be fitted onto an opening of a container main body (not shown in the drawings) and a flip-top lid 14 having a protrusion 16 projecting from an inner surface 18 for closing dispensing orifice 22 provided in top wall 24 of primary cap 12. In the exemplary embodiment of FIG. 1, cap 10 is in its open position. Cap 10 is integrally molded in one piece from highly resilient synthetic resin material such as polypropylene.

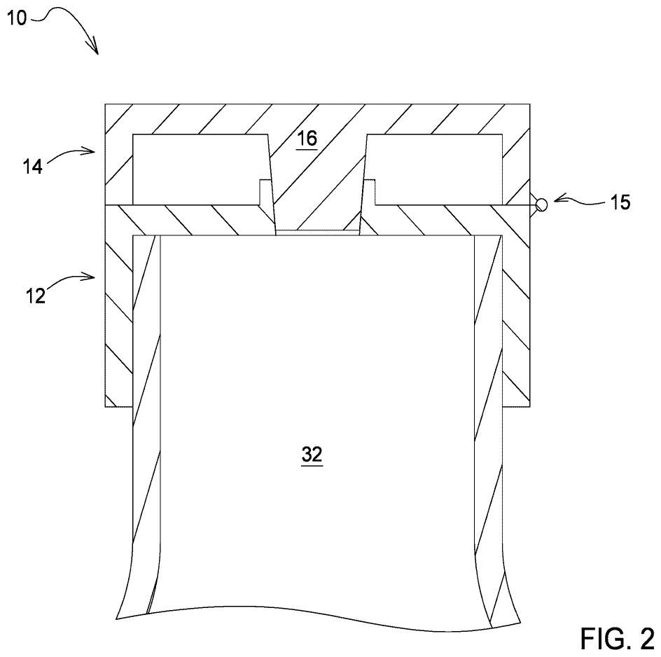

As demonstrated in FIG. 2, which shows cap 10 in its fully closed position, cap 10 fits snugly on the neck 32 of a container, with dispensing orifice 22 provided directly underneath flip-top lid 14. In many embodiments, cap 10 will have internal threads (not shown) that securely screw onto neck 32 of a container. In other embodiments, such as that in FIG. 2, cap 10 snaps onto neck 32 of a container. Yet other container connections are contemplated, for example, cap 10 may fit snuggly into container neck 32 similarly to a stopper. The only limitation is that cap 10 does not allow leakage of the container's medicinal liquid contents beyond dispensing orifice 22.

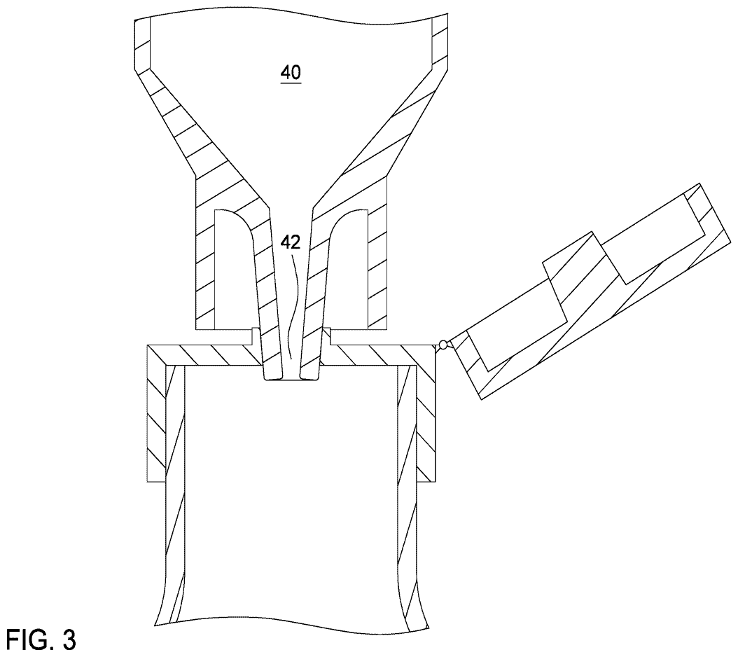

Dispensing orifice 22 in primary cap 12 is dimensioned to allow for a tight seal against a dispensing syringe 40. As demonstrated in FIG. 3, syringe 40, when inserted into dispensing orifice 22, creates a secure connection, ensuring that the medicinal liquid in container 30 is dispensed into syringe tip 42 with precision and minimal spillage. Compatibility with both slip top and luer lock syringes are considered. For example, in one embodiment, such as that shown in FIG. 3, dispensing orifice 22 is adapted to accommodate a female luer lock connector 50.

Flip-top lid 14 of cap 10 is hinged or otherwise attached to primary cap 12. Such as in the embodiment of FIG. 1, primary cap 12 and flip-top lid 14 are joined together by a thin and flexible hinge portion 15 at axial end portions of the circumferential cap walls 13. On inner surface 18 of flip-top lid 14, protrusion 16 corresponds to diameter 23 of dispensing orifice 22. When flip-top lid 14, such as demonstrated in FIG. 2, is closed, protrusion 16 forms a tight seal with dispensing orifice 22, preventing any medicinal liquid leak while safeguarding dispensing surfaces 25 from exposure to contamination.

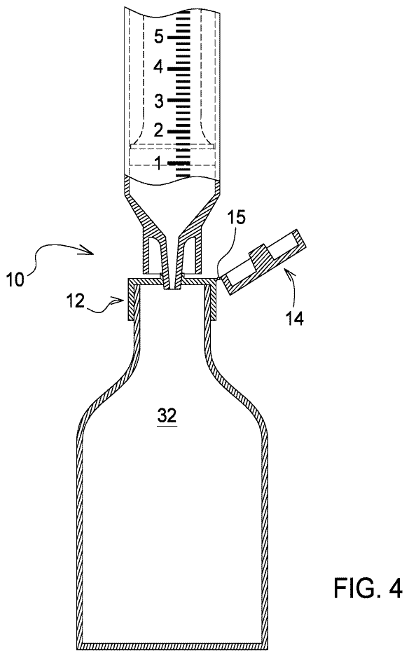

The design of cap 10 allows for two modes of medicinal liquid dispensing. First, cap 10 can be used with a dispensing syringe 40. This is shown in FIGS. 3-4. Syringe tip 42 fits into dispensing orifice 22, allowing a user to draw a precise amount of medicinal liquid into dispensing syringe 40. This drawn medicinal liquid can be dispensed directly either orally or through the addition of a needle to dispensing syringe 40. In another mode, cap 10 can be used without a syringe, with medicinal liquid being dispensed directly from container 30 via dispensing orifice 22 into a measuring device, such as a cup or medicine dosage spoon.

Flip-top lid 14 protects dispensing surfaces 25 when container 30 is not in use. By sealing dispensing orifice 22 with protrusion 15, the liquid dosing system prevents dust, dirt, or other contaminants from entering the dispensing area, maintaining the integrity of the medicinal liquid and the hygiene of the system.

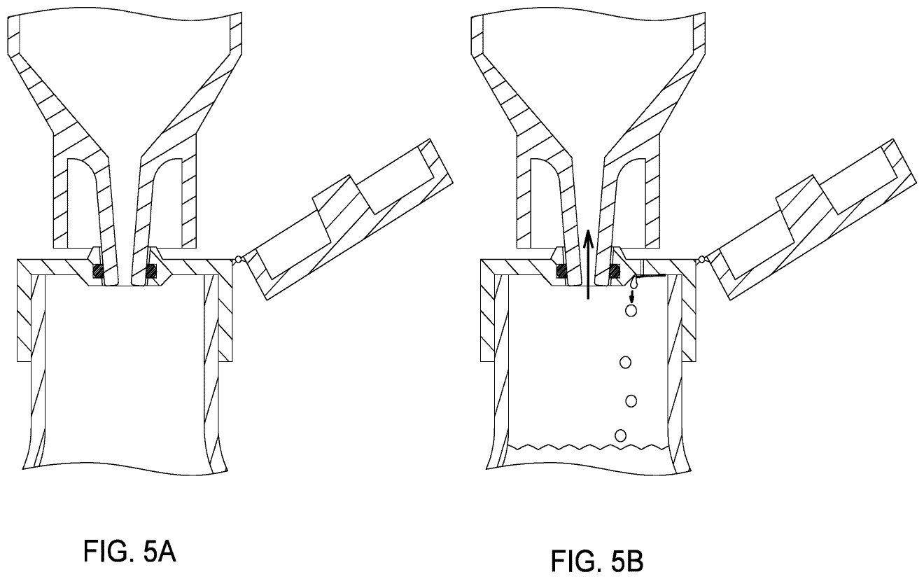

Additional embodiments are shown in FIG. 5A and FIG. 5B. In FIG. 5A, the outer circumference of dispensing orifice 22 additionally includes an annular groove 27, capable of fitting an O-Ring. FIG. 5B demonstrates a liquid tight vent 38 along with the o-ring. Liquid tight vent 38 allows larger syringe volumes to be drawn with minimal back pressure by allowing air back into container 30, thus releasing any formed vacuum.

Additionally dispensing orifice 22 may be adapted to a hose connector such has a barb or sanitary fitting. This allows the liquid dosing system to connect container 30 to a dosing gun, such has those commonly known in the art.

The size of inner diameter 23 of dispensing orifice 22 is not meant to be limiting. In one embodiment, dispensing orifice inner diameter 23 is between about 0.050″ and about 0.600″. In another embodiment, dispensing orifice inner diameter 23 is between about 0.150″ and about 0.250″. In yet another embodiment, dispensing orifice inner diameter 23 is between about 0.180″ and about 0.205.″

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” may be used to mean serving as an example, instance or illustration. Any embodiment or design described herein as “exemplary” may be not necessarily to be construed as preferred or advantageous over other embodiments or designs. Rather, use of the word exemplary may be intended to present concepts in a concrete manner. Accordingly, all such modifications are intended to be included within the scope of the present inventions. The order or sequence of any process or method steps may be varied or re-sequenced according to alternative embodiments. Any means-plus-function clause may be intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

I claim:

1. A liquid dosing system comprising:
a. a one-piece closure configured to seal the opening of a container comprising:
i. a primary cap with a dispensing orifice, wherein the dispensing orifice is dimensioned to allow a tight seal with a syringe for dispensing liquid from the container into the syringe and
ii. a flip-top lid connected to the primary cap, wherein an inner surface of the flip-top lid comprises a protrusion, wherein the protrusion is adapted to seal the dispensing orifice when the flip-top lid is closed; and further wherein the flip-top lid, when closed, protects the dispensing orifice from contamination.

2. The liquid dosing system of claim 1, wherein the primary cap comprises internal threads adapted to engage with corresponding threads on a neck of the container, such that the primary cap is securely attached to the neck of the container through engagement of the threads.

3. The liquid dosing system of claim 1, wherein the primary cap is adapted to snap onto a neck of the container.

4. The liquid dosing system of claim 1, wherein the dispensing orifice is dimensioned to accommodate a luer lock syringe or a slip-tip syringe.

5. The liquid dosing system of claim 2, wherein the dispensing orifice is dimensioned to accommodate a luer lock syringe or a slip-tip syringe.

6. The liquid dosing system of claim 3, wherein the dispensing orifice is dimensioned to accommodate a luer lock syringe or a slip-tip syringe.

7. The liquid dosing system of claim 1, wherein the primary cap further comprises a liquid-tight vent, wherein the liquid-tight vent allows for larger syringe volumes to be drawn with minimal back pressure.

8. The liquid dosing system of claim 2, wherein the primary cap further comprises a liquid-tight vent, wherein the liquid-tight vent allows for larger syringe volumes to be drawn with minimal back pressure.

9. The liquid dosing system of claim 3, wherein the primary cap further comprises a liquid-tight vent, wherein the liquid-tight vent allows for larger syringe volumes to be drawn with minimal back pressure.

10. The liquid dosing system of claim 1, wherein the dispensing orifice further comprises an annular groove configured to hold an O-ring.

11. The liquid dosing system of claim 1, wherein the primary cap and flip-top lid are integrally molded from a resilient synthetic resin material.

12. The liquid dosing system of claim 2, wherein the primary cap and flip-top lid are integrally molded from a resilient synthetic resin material.

13. The liquid dosing system of claim 3, wherein the primary cap and flip-top lid are integrally molded from a resilient synthetic resin material.

14. The liquid dosing system of claim 1, wherein the dispensing orifice has an inner diameter between about 0.050 inches and about 0.600 inches.

15. The liquid dosing system of claim 1, wherein the flip-top lid is attached to the primary cap by a thin, flexible hinge.

16. The liquid dosing system of claim 1, wherein the dispensing orifice is further adapted to connect to a hose connector or a sanitary fitting.

17. The liquid dosing system of claim 1, wherein the liquid is a medicinal liquid, and the system is configured to provide controlled dispensing of the medicinal liquid into a syringe or measuring device.

18. The liquid dosing system of claim 2, wherein the liquid is a medicinal liquid, and the system is configured to provide controlled dispensing of the medicinal liquid into a syringe or measuring device.

19. A method of dispensing liquid from a container using the liquid dosing system of claim 1, comprising:
a. providing a syringe;
b. opening the flip-top lid to expose the dispensing orifice;
c. inserting the syringe into the dispensing orifice; and
d. dispensing the liquid from the container into the syringe without removing the flip-top lid from the container.

20. A method of dispensing liquid from a container using the liquid dosing system of claim 1, comprising:
a. providing a measuring device;
b. opening the flip-top lid to expose the dispensing orifice;
c. dispensing the liquid from the container into the measuring device without removing the flip-top lid from the container.
